(19) United States
(12) Patent Application Publication
(10) Pub. No.: US 2010/0285247 A1
(43) Pub. Date: Nov. 11, 2010

(54) Combined self-sealing, and chemical and visual camouflage coating

(75) Inventors: Russell A. Monk, Salem, OR (US); Thomas S. Ohnstad, Salem, OR (US)

Correspondence Address: ROBERT D. VARITZ, P.C., 4915 SE 33RD PLACE, PORTLAND, OR, 97202, US

(73) Assignee: High Impact Technology, L.L.C.

(21) Appl. No.: 12/460,185

(22) Filed: Jul. 15, 2009

Related U.S. Application Data
(60) Provisional application No. 61/135,737, filed on Jul. 22, 2008.

(51) Int. Cl. B32B 1/02

(52) U.S. Cl. 428/34.1

(57) ABSTRACT

A combined-function protective coating for a fuel-containing structure including a self-sealing underlayer structure applied directly to such a fuel-containing structure, and an outer, chemical-agent and biological-agent resistant (CARC) overcoating material applied to the outside of the underlayer structure.

### RELATED APPLICATION

This Application is related to U.S. Provisional Patent Application Ser. No. 61/135,737, filed Jul. 22, 2008, for Combined self-sealing, and chemical and visual camouflage coating, from which this Application claims priority. The full contents of the Provisional Patent Application are incorporated herein by reference.

### FIELD OF THE INVENTION

This invention relates to protective coatings, and specifically to a combined-function protective coating for the outside surface in the wall of a fuel-container, such as a military fuel tanker.

### BACKGROUND OF THE INVENTION

The invention is described in the context of protective and visual deception coatings for military vehicles. Even military specification (mil spec) paints and coating need to be environmentally friendly. To this end, mil spec paints made IAW MIL-C-46168 type IV allows a maximum of 3.5 pounds per gallon of volatile organic compounds (VOC). Likewise, MIL-C-53039 allows a maximum of 3.5 pounds of VOC per gallon of coating. The paints meeting these standards are generally resin systems of polyureas or polyurethane-type materials. The coatings, or paints, must withstand not only the normal rigors of military activity, but must be capable of maintaining structural integrity under chemical and/or biological attacks.

Additionally, the paints, referred to as Chemical Agent Resistant Coatings (CARCs), are frequently applied over a self-sealing layer of material, particularly in the case of fuel tanks, either mobile or stationary. Thus, the CARC materials must be chemically compatible with the self-sealing materials. To that end, the invention provides a self-sealing layer and a chemically compatible CARC, which may be applied directly over the self-sealing layer, or on a primer which is applied to the self-sealing layer.

### SUMMARY OF THE INVENTION

A combined-function protective coating for a fuel-containing structure including a self-sealing underlayer structure applied directly to such a fuel-containing structure, and an outer, chemical-agent and biological-agent resistant (CARC) overcoating material applied to the outside of the underlayer structure.

This summary and objectives of the invention are provided to enable quick comprehension of the nature of the invention. A more thorough understanding of the invention may be obtained by reference to the following detailed description of the preferred embodiment of the invention in connection with the drawings.

### BRIEF DESCRIPTION OF THE DRAWINGS

FIG. 1 depicts a two-layer embodiment of the invention.

FIG. 2 depicts a three-layer embodiment of the invention.

### DETAILED DESCRIPTION OF THE PREFERRED EMBODIMENTS

The protection provided by this invention is disclosed herein in a military setting, wherein a fuel-containing structure, such as a wheeled military tanker carrying petrochemical fuel, needs to be protected against a fire-and explosion-risk ballistic puncture leak, and also needs to be guarded with an appropriate visual, chemical and biological camouflage material which adequately “hides a protected structure from obvious view”, and presents an easily cleaned and detoxified surface.

The protective coating of this invention is described herein in two embodiments, one of which involves a two-layer structure, and the other of which involves a three-layer structure.

The surface of the fuel-containing structure may be prepared with an appropriate solvent-based primer, such as a primer designated as System 251 primer made by Rhino Linings, USA, Inc. in San Diego, Calif. This primer etches the surface of a storage tank, thus enhancing the grip of subsequent layers of material thereon.

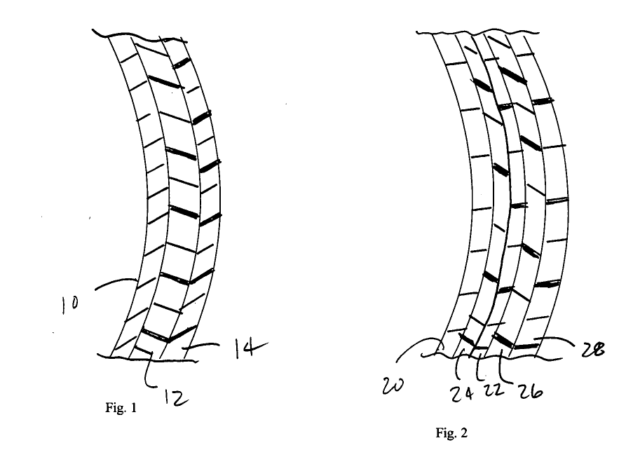

Referring now to FIG. 1, a two-layer structure of the invention is applied over a fuel-containing tank 10, most probably formed of a metal, which is suitable for fuel storage, which fuel may be gasoline, diesel or a biofuel mixture. An inner layer structure 12 functions in an anti-penetration, or penetration-defeating, self-healing fashion to close puncture wounds. Applied to the outside of this inner layer structure is an overcoating of a Chemical Agent Resistant Coating (CARC) 14 which furnishes visible, chemical and biological camouflaging.

In this embodiment of the invention, coating materials are chosen which preferably are chemically compatible with one another, whereby they bond to one another in a way which is directly associated with that chemical compatibility. For example, a very suitable self-sealing layer structure may be formed in accordance with the structure described in U.S. Pat. No. 7,044,166, for Liquid Tank Puncture Repair Kit and Method, to Monk et al., granted May 16, 2006, the entire contents of which are incorporated herein by reference. This material is a urethane based material which is applied initially as a flowable material, and which then cures to completeness. With this self-sealing material applied to, and in place on the outside surface of, a protected structure, and before full curing of the material, the overlayer CARC material is directly applied to join with the self-sealing layer during curing of the latter, usually within four to six hours of application of the self-sealing layer.

Referring now to FIG. 2, a fuel-containing tank 20 is to be retrofit with the coating of the invention, which includes the same kind of anti-penetration, self sealing layer structure 22 as in FIG. 1, layer 12, however, the self-sealing layer is applied and allowed completely to cure before CARC material is applied. An optional primer layer 24 may be applied to the tank prior to application of self-sealing layer 22, or before application of layer 12 in the first embodiment hereof. After curing of the self-sealing layer structure, a primer 26, such as the previously described solvent-based primer, is applied to the outside of the self-sealing layer structure, and it is onto the outside surface of this primer material that a CARC overcoating layer 28 is thereafter applied.

Thus, a combined-function protective coating for a for a fuel-containing structure has been disclosed. It will be appreciated that further variations and modifications thereof may be made within the scope of the invention as defined in the appended claims.

We claim:

1. A combined-function protective coating for a fuel-containing structure including (a) a self-sealing underlayer structure applied directly to such a fuel-containing structure, and (b) an outer, chemical-agent and biological-agent resistant (CARC) overcoating material applied to the outside of the underlayer structure.

2. The coating of claim 1 wherein the underlayer structure originated as a flowable, curable material, the CARC overcoating material is chemically compatible with the underlayer material, and the CARC overcoating material has been applied to the underlayer structure before the underlayer material fully has cured.

3. The coating of claim 1 wherein the underlayer structure originated as a flowable, curable material which has fully cured, and wherein a solvent-based primer is applied to the fully cured underlayer structure forming a solvent-based primer layer thereon, and wherein the CARC overcoating material is chemically compatible with the underlayer material and the solvent-based primer, and wherein the CARC overcoating material has been applied to the solvent-based primer layer.

4. The coating of claim 1 which further includes a primer layer applied directly to the fuel-containing structure, and wherein the underlayer structure originated as a flowable, curable material applied directly to the primer layer, and the CARC material has been applied to the underlayer material after underlayer-material curing has taken place.

5. A combined-function protective coating for a fuel-containing structure including (a) a primer layer formed of a solvent-based primer applied directly to the fuel-containing structure, (b) a self-sealing underlayer structure applied directly to the primer layer, and (c) an outer, chemical-agent and biological-agent resistant (CARC) overcoating material applied to the outside of the underlayer structure.

6. The coating of claim 5 wherein the underlayer structure originated as a flowable, curable material, the CARC overcoating material is chemically compatible with the underlayer material, and the CARC overcoating material has been applied to the underlayer structure before the underlayer material fully has cured.

7. The coating of claim 5 wherein the underlayer structure originated as a flowable, curable material which has fully cured, and wherein a solvent-based primer is applied to the fully cured underlayer structure forming a solvent-based primer layer thereon, and wherein the CARC overcoating material is chemically compatible with the underlayer material and the solvent-based primer, and wherein the CARC overcoating material has been applied to the solvent-based primer layer.
